(19) United States
(12) Patent Application Publication
(10) Pub. No.: US 2009/0259813 A1
(43) Pub. Date: Oct. 15, 2009

(54) MULTI-PROCESSOR SYSTEM AND METHOD OF CONTROLLING THE MULTI-PROCESSOR SYSTEM

(75) Inventor: Kenta YASUFUKU, Kawasaki-Shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/404,631

(22) Filed: Mar. 16, 2009

(30) Foreign Application Priority Data
Apr. 10, 2008 (JP) 2008-102697

(51) Int. Cl. G06F 12/08; G06F 12/00

(52) U.S. Cl. 711/122; 711/E12.001; 711/E12.024

(57) ABSTRACT

A multi-processor system has a plurality of processor cores, a plurality of level-one caches, and a level-two cache. The level-two cache has a level-two cache memory which stores data, a level-two cache tag memory which stores a line bit indicative of whether an instruction code included in data stored in the level-two cache memory is stored in the plurality of level-one cache memories or not line by line, and a level-two cache controller which refers to the line bit stored in the level-two cache tag memory and releases a line in which data including the same instruction code as that stored in the level-one cache memory is stored, in lines in the level-two cache memory.

### CROSS-REFERENCE TO RELATED APPLICATION

This application is based upon and claims the benefit of priority from the prior Japanese Patent Application No. 2008-102697, filed on Apr. 10, 2008; the entire contents of which are incorporated herein by reference.

### BACKGROUND OF THE INVENTION

1. Field of the Invention

The present invention relates to a multi-processor system and a method of controlling the multi-processor system and, more particularly, to a multi-processor system having an instruction cache and a method of controlling the multi-processor system.

2. Related Art

A general multi-processor system has level-one caches provided for a plurality of processor cores in a one-to-one corresponding manner and a level-two cache shared by the processor cores.

A part of processor systems having the level-one and level-two caches is provided with the function of exclusively controlling data stored in the level-one caches and data stored in the level-two cache in order to effectively use the capacity of the level-one and level-two caches (hereinbelow, called “exclusive caches”). A conventional processor system, see Japanese Patent Application National Publication (Laid-Open) No. (Translation of PCT Application) No. 2007-156821, employing the exclusive caches has a level-one cache and a level-two cache having the same line size from the viewpoint of controllability. Therefore, when the line size of the level-two cache increases, the line size of the level-one cache also increases. On the other hands, when the line size of the level-two cache decreases, the line size of the level-one cache also decreases.

Generally, when a larger amount of data is transferred at a time, the use efficiency of a bus and an off-chip DRAM is higher. Consequently, larger line size of a level-two cache is preferable. However, in the case where the line size of a level-one cache is large, the size of a buffer used in the case of transferring data to the level-one cache is also large, so that the scale and cost of hardware increase. In particular, in the case of a multi-processor system, buffers of the same number as that of processors are necessary. Therefore, the influence of increase in the size of the buffer on the scale and cost of hardware is large.

That is, when the line size of the level-one cache is large, the scale and cost of hardware increases. On the other hands, when the line size of the level-two cache is small, the use efficiency of a bus and a DRAM decreases.

### BRIEF SUMMARY OF THE INVENTION

According to the first aspect of the present invention, there is provided a multi-processor system comprising:

a plurality of processor cores which requests and processes data;

a plurality of level-one caches having level-one cache memories connected to the plurality of processor cores in a one-to-one corresponding manner; and

a level-two cache shared by the plurality of processor cores and whose line size is larger than that of the level-one cache,

wherein the level-two cache comprises:

a level-two cache memory which stores the data;

a level-two cache tag memory which stores a line bit indicative of whether an instruction code included in data stored in the level-two cache memory is stored in the plurality of level-one cache memories or not line by line; and

a level-two cache controller which refers to the line bit stored in the level-two cache tag memory and releases a line in which data including the same instruction code as that stored in the level-one cache memory is stored, in lines in the level-two cache memory.

According to the second aspect of the present invention, there is provided a method of controlling a multi-processor system comprising:

a plurality of processor cores which requests and processing data;

a plurality of level-one caches connected to the plurality of processor cores in a one-to-one corresponding manner; and

a level-two cache shared by the plurality of processor cores and whose line size is larger than that of the level-one cache,

wherein the method comprises:

referring to a line bit indicative of whether an instruction code included in data stored in the level-two cache is stored in the plurality of level-one cache or not; and

releasing a line in which data including the same instruction code as that stored in the level-one cache is stored, in lines in the level-two cache memory.

### BRIEF DESCRIPTION OF THE DRAWINGS

FIG. 1 is a block diagram showing the configuration of a multi-processor system 100 as the first embodiment of the present invention.

FIG. 2 is a schematic diagram showing a data structure in an initial state of the L1 cache tag memories 102A2 and 102B2 and the L2 cache tag memory 103B in the first embodiment of the present invention.

FIG. 3 is a flowchart showing the procedure of process of fetching an instruction code of the multi-processor as the first embodiment of the present invention.

FIG. 4 is a schematic diagram showing a outline of a refilling process of way (S305 of FIG. 3) and an example of a program for realizing the refilling process.

FIGS. 5 and 6 are schematic diagrams showing a data structure in a state of the L1 cache tag memories 102A2 and 102B2 and the L2 cache tag memory 103B in the first embodiment of the present invention, after a process of the multi-processor system 100.

FIG. 7 is a schematic diagram showing the data structure of the L1 cache tag memories 102A2 and 102B2 and the L2 cache tag memory 103B in the state after the operation of the multi-processor system 100 as the second embodiment of the present invention is performed.

FIGS. 8 and 9 are schematic diagrams showing a data structure in a state of the L1 cache tag memories 102A2 and 102B2 and the L2 cache tag memory 103B in the second embodiment of the present invention, after a process of the multi-processor system 100.

FIG. 10 is a schematic diagram showing a data structure in a state of the L1 cache tag memories 102A2 and 102B2 and the L2 cache tag memory 103B in the third embodiment of the present invention, after a process of the multi-processor system 100.

### DETAILED DESCRIPTION OF THE INVENTION

Embodiments of the present invention will be described below with reference to the drawings. The following embodiments of the present invention are aspects of carrying out the present invention and do not limit the scope of the present invention.

### First Embodiment

A first embodiment of the preset invention will be described. The first embodiment of the present invention relates to an example in which a level-two (L2) cache controller reads data requested by a processor core (hereinbelow, called “requested data”) from a level-two (L2) cache memory and supplies the requested data to the processor core.

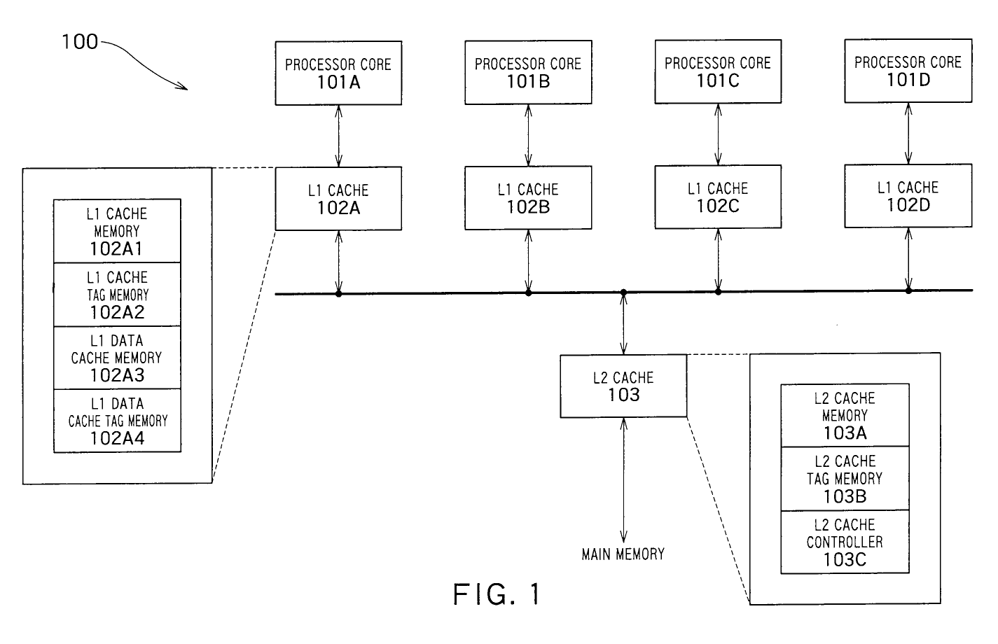

FIG. 1 is a block diagram showing the configuration of a multi-processor system 100 as the first embodiment of the present invention.

The multi-processor system 100 has a plurality of processor cores 101A to 101D, a plurality of level-one (L1) caches 102A to 102D, and a level-two (L2) cache 103.

The processor cores 101A to 101D request and process data including an instruction code and operation data. The processor cores 101A to 101D access instruction codes and operation data stored in the L2 cache 103 via the L1 caches 102A to 102D, respectively.

The L1 caches 102A to 102D are connected to the processor cores 101A to 101D, respectively. The L1 cache 102A has instruction caches (an L1 cache memory 102A1 and an L1 cache tag memory 102A2) which stores an instruction code, and data caches (an L1 data cache memory 102A3 and an L1 data cache tag memory 102A4) which stores the operation data. Like the L1 cache 102A, the L1 caches 102B to 102D have instruction caches (L1 instruction cache memories 102B1 to 102D1 (not shown) and L1 instruction cache tag memories 102B2 to 102D2 (not shown)) and data caches (L1 data cache memories 102B3 to 102D3 (not shown) and L1 data cache tag memories 102B4 to 102D4 (not shown)). Each of the instruction caches and the data caches of the L1 caches 102A to 102D has a line size of 64 B.

The L2 cache 103 is provided so as to be shared by the processor cores 101A to 101D via the L1 caches 102A to 102D, respectively and connected to a not-shown main memory. The L2 cache 103 employs the 2-way set-associative method of the LRU (Least Recently Used) policy, and has a line size of 256 B which is larger than the line size of the L1 caches 102A to 102D. The capacity of the L2 cache 103 is 256 KB. The L2 cache 103 has an L2 cache memory 103A, an L2 cache tag memory 103B, and an L2 cache controller 103C. The line size of the L2 cache 103 has to be “k” times (k: an integer of 2 or larger) of the line size of the L1 caches 102A and 102D. In the first embodiment of the present invention, k is equal to 4.

The L2 cache memory 103A stores the data including the instruction code and operation data.

The L2 cache tag memory 103B stores a line bit indicative of whether an instruction code included in data stored in the L2 cache memory 103A is stored in the plurality of L1 cache memories 102A1 to 102D1 or not, a valid bit indicative of validity of the data stored in the L2 cache memory 103A, and a dirty bit indicative of whether data stored in the L2 cache memory 103A has been changed or not, line by line in each way. The L2 cache tag memory 103B stores a replace bit indicative of a way to be refilled with data stored in the L2 cache memory 103A in each of lines common to the ways. Since the L2 cache 103 employs the 2-way set-associative method of the LRU policy, the value of the replace bit is inverted each time its entry is accessed.

In the case data is requested by the processor cores 101A to 101D, the L2 cache controller 103C refers to the valid bit and the tag address stored in the L2 cache tag memory 103B. In the case that the address of requested data is not registered, a cache miss is determined, and refilling operation is performed. In the refilling operation, the main memory is accessed, and the data stored in the main memory is written into the L2 cache memory 103A and supplied to the processor cores 101A to 101D. In a state where 1 is set in the valid bit of the line to be refilled (that is, in the case where valid data is already stored), the data is replaced and overwritten. In a state where 1 is set in the dirty bit in the line to be replaced (that is, in the case where data has been changed), data to be overwritten is written back in the main memory. The L2 cache controller 103C reads data in the main memory in units of 256 B as the line size of the L2 cache 103, and supplies data to the processor cores 101A to 101D in units of 64 B as the line size of the instruction cache of the L1 caches 102A to 102D.

When the L2 cache controller 103C reads data from the main memory and writes it to the L2 cache memory 103A, the L2 cache controller 103C updates the data in the L2 cache tag memory 103B, sets 1 in the valid bit, sets 0 in the dirty bit, sets 0 in the line bit, inverts the value of the replace bit, and stores a part of the address in a tag address.

The L2 cache controller 103C transfers the data stored in the L2 cache memory 103A to the L1 instruction cache memories 102A1 to 102D1 in accordance with an address requested by the processor cores 101A to 101D. At this time, in the case where the processor cores 101A to 101D request for an instruction code, 1 is set in the line bit in the L2 cache tag memory 103B corresponding to a line in which the data is stored. The process is performed irrespective of whether data is transferred to any of the L1 caches 102A to 102D or not.

In the case where the L2 cache controller 103C repeats the above-described operation and, when a cache miss occurs, selects a way to be replaced in a certain line, a way in which 1 is set in all of line bits is preferentially selected. As a result, a line corresponding to data including the same instruction code as that stored in the L1 instruction cache memories 102A1 to 102D1 is released from the L2 cache memory 103A.

In the first embodiment, each of the number of the processor cores 101 and the number of the L1 caches 102 is arbitrary as long as it is plural.

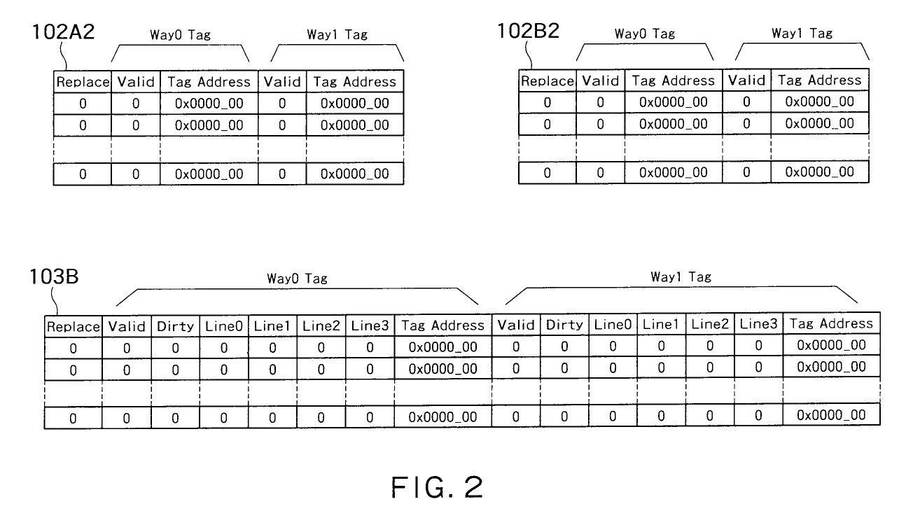

FIG. 2 is a schematic diagram showing a data structure in an initial state of the L1 cache tag memories 102A2 and 102B2 and the L2 cache tag memory 103B in the first embodiment of the present invention.

Each of the L1 instruction cache tag memories 102A2 and 102B2 includes a valid bit, and a tag address for each way of one line, and a replace bit for each line.

The L2 cache tag memory 103B includes a valid bit, a dirty bit, a plurality of line bits (lines 0 to 3), and a tag address for each way of one line, and a replace bit for each line. The valid bit is a bit indicative of validity of data stored in the L2 cache memory 103A. The replace bit is a bit indicative of a way to be refilled with the data stored in the L2 cache memory 103A. The line bit has the number of bits as “line size of the L2 cache 103/line size of the L1 cache”. When the line size of the L2 cache 103 is 256 B and the line size of the L1 cache 102 is 64 B, the number of line bits is 4 (=256/64).

In the initial state, 0 is set in the bits of the L1 instruction cache tag memories 102A2 and 102B2 and the L2 cache tag memory 103B.

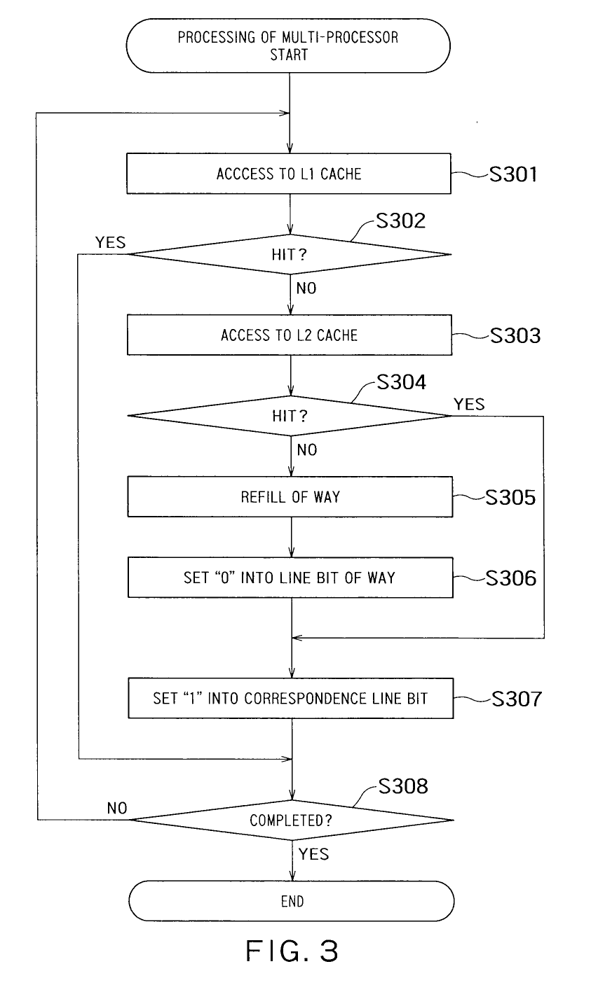

FIG. 3 is a flowchart showing the procedure of process of fetching an instruction code of the multi-processor as the first embodiment of the present invention.

First, the L1 cache 102A is accessed (S301). At this time, it is checked whether an instruction code in the requested data of the processor core 101A is stored in the L1 instruction cache memory 102A1 or not, based on the data in the L1 instruction cache tag memory 102A2.

In the case where the instruction code of the requested data of the processor core 101A is not stored in the L1 instruction cache memory 102A1 in S301 (NO in S302), the L2 cache 103 is accessed (S303). At this time, it is checked whether the requested data of the processor core 101A is stored in the L2 cache memory 103A or not, based on the data in the L2 cache tag memory 103B.

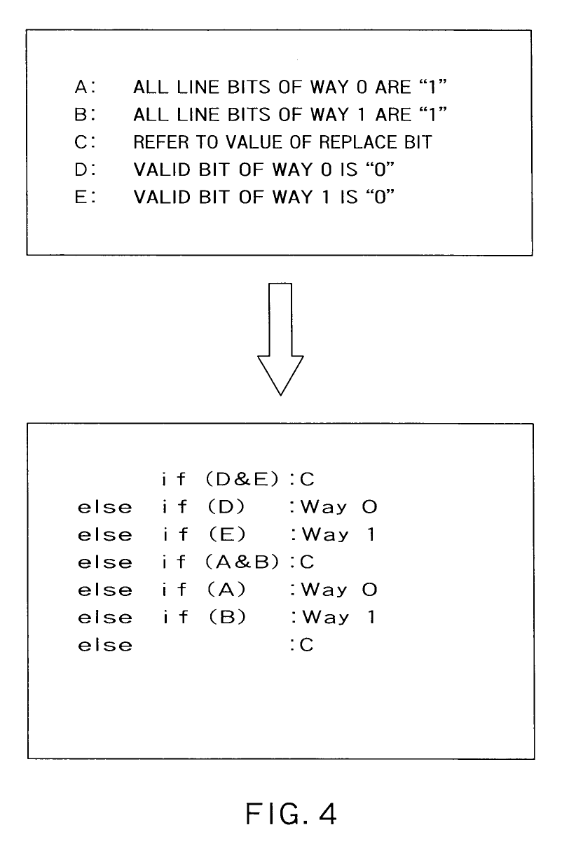

In the case where the requested data of the processor core 101A is not stored in the L2 cache memory 103A in S303 (NO in S304), a way is refilled (S305). At this time, as shown in FIG. 4, when the valid bits of the way 0 and the way 1 are 0, a way corresponding to the value of the replace bit is refilled. In the case where only the valid bit of the way 0 is 0, the way 0 is refilled. In the case where only the valid bit of the way 1 is 0, the way 1 is refilled. In the case where all of line bits in the ways 0 and 1 are 1, a way corresponding to the value of the replace bit is refilled. In the case where only all of line bits in the way 0 are 1, the way 0 is refilled. In the case where only all of line bits in the way 1 are 1, the way 1 is refilled. In the other cases, a way corresponding to the value of the replace bit is refilled.

Next, 0 is set in all of line bits of the way refilled in S305 (S306).

1 is set in a line bit corresponding to the line in which data is stored (S307).

When the instruction code in the requested data of the processor core 101A is stored in the L1 cache memory 102A1 in S301 (YES in S302), S308 is performed.

On the other hand, when the instruction code in the requested data of the processor core 101A is stored in the L2 cache memory 103A in S303 (YES in S304), S307 is preformed.

S301 to S307 are repeated until the process of the multi-processor is completed (NO in S308).

A concrete example of the operation of the multi-processor system 100 as the first embodiment of the present invention will now be described.

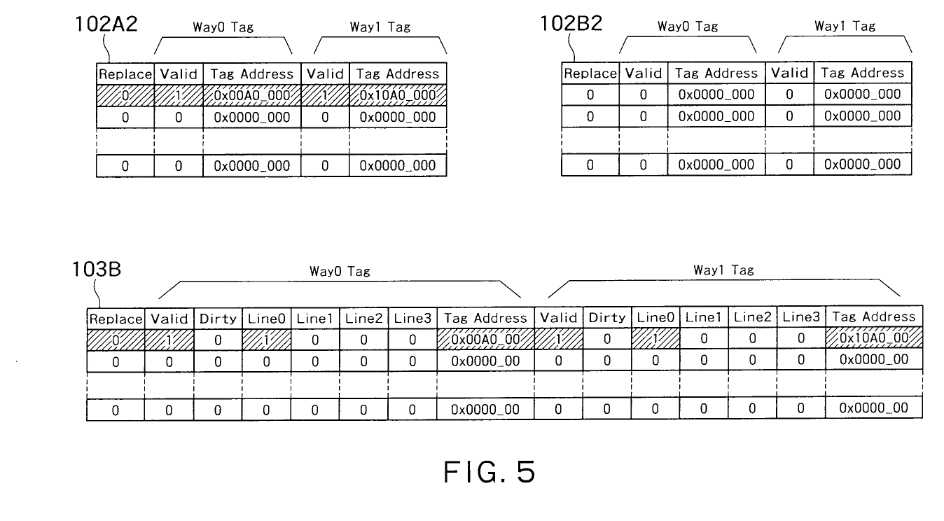

For example, when an instruction code stored in an address (0x00A0_{—}0000) is requested by the processor core 101A, the instruction code is transferred from the main memory to the L2 cache memory 103A, then is transferred from the L2 cache memory 103A to the L1 cache memory 102A1. As a result, 1 is set in the replace bit in the L1 instruction cache tag memory 102A2, 1 is set in the valid bit in way 0, the tag address (0x00A0_{—}0000) is set in way 0, 1 is set in the replace bit in the L2 cache tag memory 103B, 1 is set in the valid bit in way 0, 1 is set in the line bit in way 0, and the tag address (0x00A0_{—}0000) is set in way 0. An instruction code stored in an address (0x10A0_{—}0000) also is requested by the processor core 101A, the instruction code is transferred from main memory to way 1 of L2 cache memory 103A and L1 cache memory 102A1. As a result, as shown in FIG. 5, 0 is set in the replace bit in the L1 instruction cache tag memory 102A2, 1 is set in the valid bit in way 1, the tag address (0x10A0_{—}0000) is set in way 1, 0 is set in the replace bit in the L2 cache tag memory 103B, 1 is set in the valid bit in way 1, 1 is set in the line bit in way 1, and the tag address (0x10A0_{—}0000) is set in way 1.

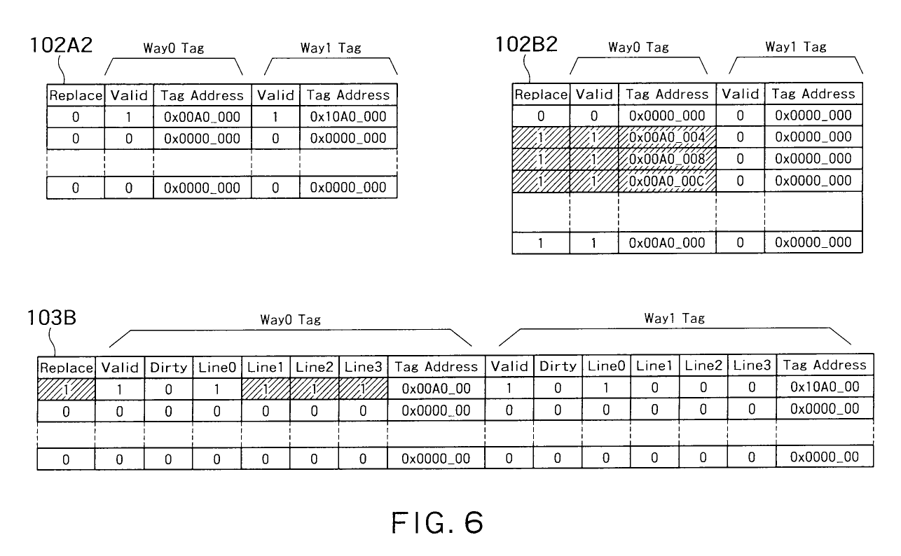

When the processor core 101B requests the instruction code with addresses (0x00A0_{—}004, 0x00A0_{—}008, and 0x00A0_{—}00C), that is three requests, the instruction code is transferred from the L2 cache memory 103A to the L1 cache memory 102B1. As a result, as shown in FIG. 6, 1 is set in the replace bit in the L1 cache tag memory 102B2, 1 is set in the valid bit in way 0, 0x00A0_{—}004, 0x00A0_{—}008, and 0x00A0_{—}00C are set as tag addresses in way 0, 1 is set in the replace bit in the L2 cache tag memory 103B, and 1 is set in the line bit in way 0.

In the case where the line becomes an object to be refilled in a state where all of the line bits in way 0 are 1, although the value of the replace bit is 1, way 0 is refilled.

In the first embodiment of the present invention, at the time of selecting an object to be replaced, the L2 cache controller 103C preferentially selects a way in which 1 is set in all of line bits. Alternatively, when 1 is set in all of line bits, 0 may be set in the valid bit in the line.

According to the first embodiment of the present invention, a line including the same instruction code as that stored in the L1 cache memories 102A1 to 102D1 is released from the L2 cache 103. Consequently, the cache size can be effectively used. Moreover, the scale and cost of the hardware of the multi-processor system 100 are reduced, the use efficiency of a bus and the memory is improved, and power consumption can be reduced.

### Second Embodiment

A second embodiment of the present invention will now be described. The second embodiment of the invention relates to an example in which an L2 cache controller transfers an instruction code requested by a processor core from a not-corresponding L1 cache to a corresponding L1 cache. The description similar to that of the first embodiment of the present invention will not be repeated.

An example of the case where an instruction code requested by the processor core 101A is not stored in the corresponding L1 instruction cache memory 102A1 and the L2 cache memory 103A but is stored in the L1 cache memory 102A1 which is not corresponding will be described.

When the instruction code is requested by the processor core 101A, the L2 cache controller 103C of the second embodiment of the present invention checks whether the requested data of the processor core 101A is stored in the L2 cache memory 103A or not.

In the case where the instruction code requested by the processor core 101A is stored in the L2 cache memory 103A, the L2 cache controller 103C transfers the data stored in the L2 cache memory 103A to the L1 instruction cache memory 102A1.

On the other hand, in the case where the requested data of the processor core 101A is not stored in the L2 cache memory 103A, the L2 cache controller 103C checks whether or not the same instruction code as that of the requested data of the processor core 101A is stored in the L1 instruction cache memories 102B1 to 102D1 which are not corresponding to the processor core 101A.

In the case where the same instruction code as that of the requested data of the processor core 101A is stored in the L1 cache memory 102B1 to 102D1, the L2 cache controller 103C transfers the instruction code to the L1 instruction cache memory 102A1 to supply the instruction code stored in the L1 cache memory 102B1 to 102D1 to the processor core 101A.

On the other hand, in the case where the same instruction code as that of the requested data of the processor core 101A is not stored in the L1 instruction cache memory 102B1 to 102D1, the L2 cache controller 103C reads the instruction code of data of the line size (256 B) of the L2 cache 103 from the main memory and stores the instruction code in the L2 cache memory 103A. The L2 cache controller 103C transfers instruction code to the L1 cache memory 102A1 to supply the instruction code of line size (64 B) of the L1 cache 102A (the instruction code of the requested data) to the processor core 101A.

The L2 cache controller 103C checks whether an instruction code of not-requested data which is not requested by the processor core 101A, in the data read from the main memory, is stored in the L1 instruction cache memories 102A1 to 102D1 or not.

In the case where an instruction code of not-requested data of the processor core 101A, in the data read from the main memory, is stored in the L1 instruction cache memories 102A1 to 102D1, the L2 cache controller 103C sets 1 in a line bit corresponding to the location in which the instruction code is stored. In the case of selecting an object to be replaced, in a manner similar to the first embodiment of the present invention, a location in which 1 is set in all of line bits is selected as an object to be replaced. Consequently, a line corresponding to the data including the same instruction code as that stored in the L1 cache memories 102A1 to 102D1 is released from the L2 cache memory 103A.

A concrete example of the operation of the multi-processor system 100 as the second embodiment of the present invention will now be described.

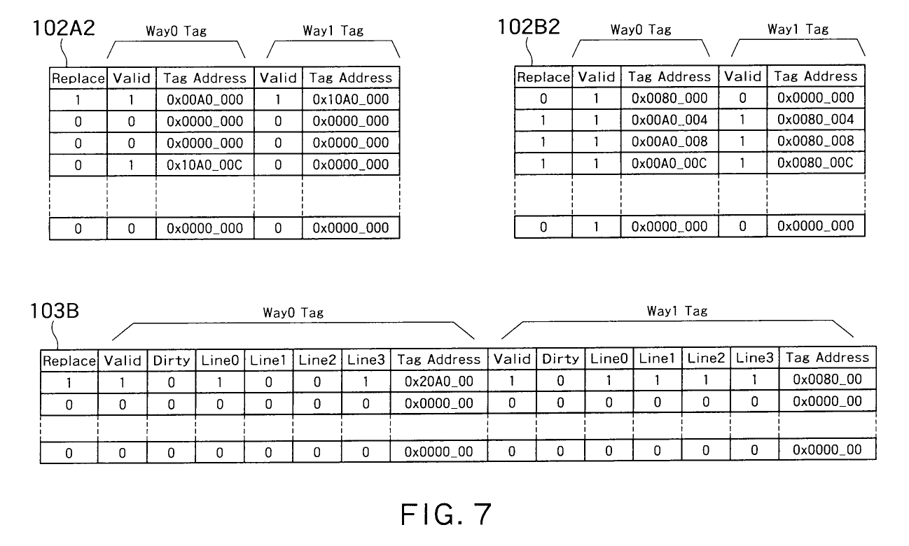

FIG. 7 is a schematic diagram showing the data structure of the L1 cache tag memories 102A2 and 102B2 and the L2 cache tag memory 103B in the state after the operation of the multi-processor system 100 as the second embodiment of the present invention is performed.

After the operation of the multi-processor system 100 as the second embodiment of the present invention is performed, a replace bit, a valid bit, and a tag address are set in a part of the L1 instruction cache tag memories 102A2 and 102B2, and a replace bit, a valid bit, a line bit, and a tag address are set in a part of the L2 cache tag memory 103B.

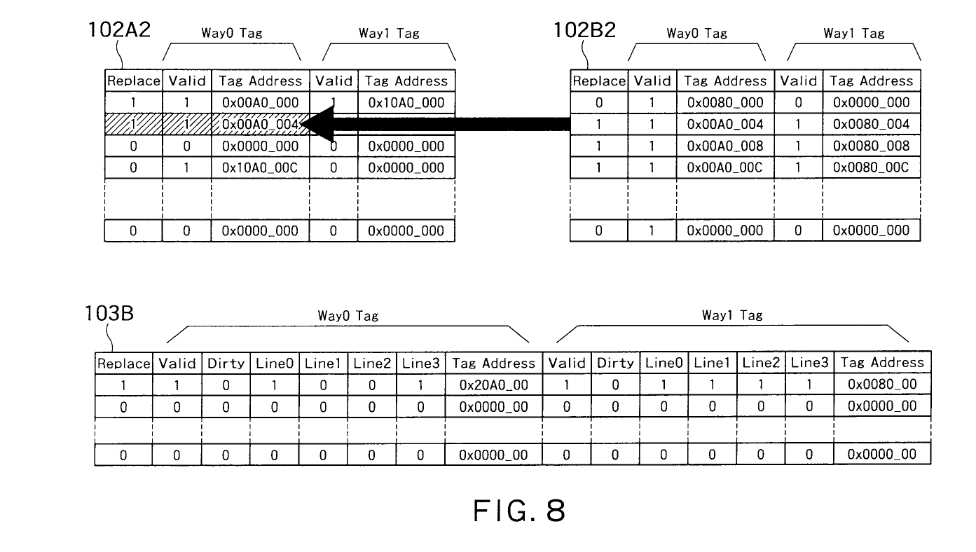

When the address (0x00A0_{—}004) is requested by the processor core 101A and an instruction code corresponding to the tag address is stored in the L1 instruction cache memory 102B1, the instruction code is transferred from the L1 cache memory 102B1 to the L1 instruction cache memory 102A1. As a result, as shown in FIG. 8, 1 is set as the replace bit in the L1 cache tag memory 102A2, 1 is set in the valid bit in way 0, and the tag address (0x00A0_{—}004) is set in way 0.

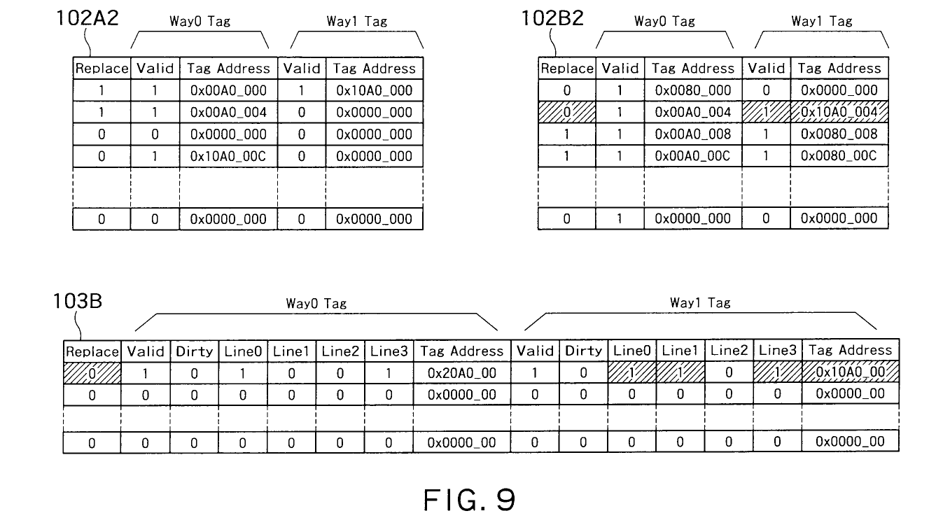

In the case where the address (0x10A0_{—}004) is requested by the processor core 101B and an instruction code corresponding to the tag address is not stored in the L1 instruction cache memories 102A1 to 102D1, when the instruction code corresponding to the tag address is transferred from the main memory to the L1 instruction cache memory 102B1. As shown in FIG. 9, the same instruction code as that in the data of the tag address (0x10A0_{—}000) and the tag address (0x10A00C) in the L2 cache memory 103A is stored in the L1 instruction cache memory 102A1, 0 is set in the replace bit in the L1 instruction cache tag memory 102B2, 1 is set in the valid bit in way 1, the tag address (0x10A0_{—}004) is set in way 1, 0 is set in the replace bit in the L2 cache tag memory 103B, 1 is set in line bits (lines 0, 1, and 3) in way 1, and the tag address (0x10A0_{—}00) is set in way 1.

In the second embodiment of the present invention, in the case where accesses of the processor cores 101A to 101D to the L1 cache memories 102A1 to 102D1 and the instruction L1 cache tag memories 102A2 to 102D2 and an access of the L2 cache controller 103C to them collide, priority is given to the accesses of the processor cores 101A to 101D.

According to the second embodiment of the present invention, in the case where the instruction code requested by the processor core 101A is not stored in the L1 instruction cache memory 102A1 and the L2 cache memory 103A but is stored in the not-corresponding L1 cache memories instructions 102B1 to 102D1, the data is read from the not-corresponding L1 cache memories 102B1 to 102D1 and written to the corresponding L1 cache memory 102A1 to supply the data to the processor core 101A. Thus, the number of accesses to the main memory can be reduced.

According to the second embodiment of the present invention, in the case where accesses of the processor cores 101A to 101D to the L1 cache memories 102A1 to 102D1 and the L1 instruction cache tag memories 102A2 to 102D2 and an access of the L2 cache controller 103C to them collide, priority is given to the accesses of the processor cores 101A to 101D. Therefore, the effect can be achieved without deteriorating the performance of the processor cores 101A to 101D.

### Third Embodiment

A third embodiment of the present invention will now be described. The third embodiment of the invention relates to an example in which an L2 cache controller transfers only an instruction code of requested data of a processor core from a main memory to a corresponding L1 cache. The description similar to those of the first and second embodiments of the present invention will not be repeated.

An example of the case where an instruction code requested by the processor core 101A is not stored in the corresponding L1 instruction cache memory 102A1 and the L2 cache memory 103A but is stored in the L1 instruction cache memory 102B1 which is not corresponding will be described.

When data is requested by the processor core 101A, the L2 cache controller 103C of the third embodiment of the present invention checks whether the requested data of the processor core 101A is stored in the L2 cache memory 103A and the not-corresponding L1 cache memories 102B1 to 120D1 in order.

In the case where the requested data of the processor core 101A is stored in any of the memories, the L2 cache controller 103C checks whether data to be stored in the same line in the L2 cache 103 as the requested data of the processor core 101A is stored in the L1 instruction memories 102A1 to 102D1 or not.

In the case where the requested data of the processor core 101A does not exist in the L2 cache 103 and the plurality of L1 instruction cache memories 102A1 to 102D1, the requested data has to be transferred from the main memory. At this time, before a transfer request of the requested data to the main memory, the L2 cache controller 103C checks whether or not not-requested data to be stored together with the requested data (data to be stored in a line in which the requested data is stored) exists in the plurality of L1 instruction cache memories 102A1 to 102D1 or not.

In the case where not-requested data of the processor core 101A does not exist also in any of the L1 instruction cache memories 102A1 to 102D1, the L2 cache controller 103C requests to transfer data of the amount of the line size (256 B) of the L2 cache 103, in the data stored in the main memory. The L2 cache controller 103C reads data of the amount of the line size (256 B) of the L2 cache 103 from the main memory, stores the data into the L2 cache memory 103A, and supplies it to the processor core 101A. For example, in the case where the line size of the L2 cache 103 is 256 B and the line size of each of the instruction cache and the data cache in the L1 caches 102A to 102D is 64 B, the requested data is made of one block (64 B) and the not-requested data is made of three blocks (192 B). When the not-requested data of only two blocks or less exists, it is determined that the not-requested data does not exist.

On the other hand, in the case where the not-requested data of the processor core 101A exists in any of the L1 cache memories 102A1 to 102D1, the L2 cache controller 103C requests to transfer only the requested data of the processor core 101A, reads only the requested data from the main memory, and directly supplies the requested data to the processor core 101A without storing the requested data into the L2 cache memory 103A.

A concrete example of the operation of the multi-processor system 100 as the third embodiment of the present invention will now be described.

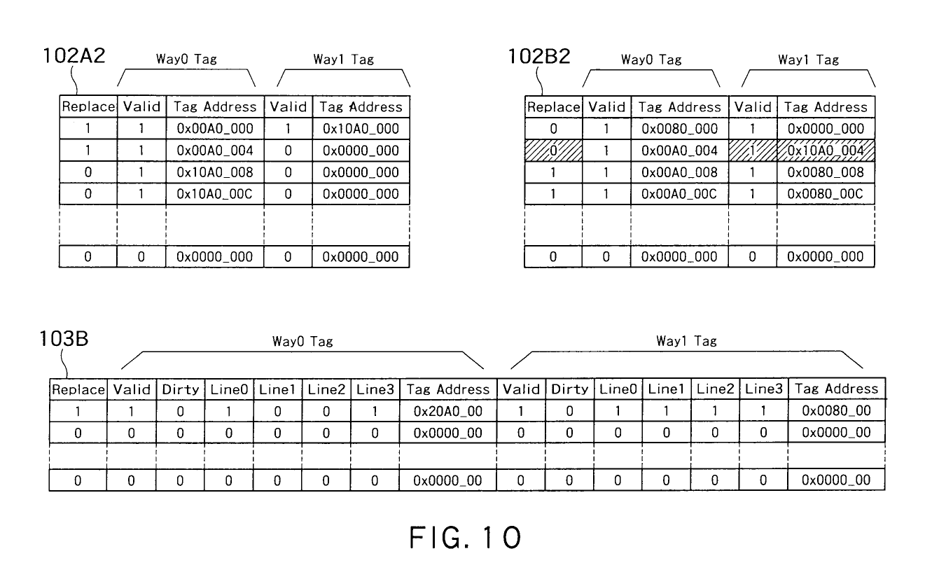

As shown in FIG. 10, when a tag address (0x10A0_{—}004) is requested by the processor core 101B and, an instruction code corresponding to the tag address is not stored in the L1 cache memories 102A1 to 102D1 but data to be disposed on a line in the L2 cache 103 which is the same as that of the requested data of the processor core 101B is stored in the L1 cache memory 102A1. Consequently, the L2 cache controller 103C transfers only the requested data of the processor core 101B from the main memory to the L1 cache memory 102B1. 0 is set in the replace bit in the L1 cache tag memory 102B2, 1 is set in the valid bit in way 1, and the tag address (0x10A0_{—}004) is set in way 1.

In the third embodiment of the present invention, data stored in the L2 cache memory 103A is not overwritten. Thus, the size of the L2 cache 103 can be effectively used.

In the third embodiment of the present invention, the transfer amount of data from the main memory to the L1 caches 102A to 102D is only the amount of the line size of the L1 caches 102A to 102D. Consequently, power consumption for an access of the main memory and consumption of the bandwidth of the main memory can be reduced.

What is claimed is:

1. A multi-processor system comprising:
a plurality of processor cores which requests and processes data;
a plurality of level-one caches having level-one cache memories connected to the plurality of processor cores in a one-to-one corresponding manner; and
a level-two cache shared by the plurality of processor cores and whose line size is larger than that of the level-one cache,
wherein the level-two cache comprises:
a level-two cache memory which stores the data;
a level-two cache tag memory which stores a line bit indicative of whether an instruction code included in data stored in the level-two cache memory is stored in the plurality of level-one cache memories or not line by line; and
a level-two cache controller which refers to the line bit stored in the level-two cache tag memory and releases a line in which data including the same instruction code as that stored in the level-one cache memory is stored, in lines in the level-two cache memory.

2. The multi-processor system according to claim 1, wherein the level-two cache controller sets a replace bit indicative of a way to which a line that stores data including the same instruction code as that stored in the level-one cache belongs.

3. The multi-processor system according to claim 1, wherein the level-two cache controller sets a valid bit so as to make the line which stores the data including the same instruction code as that stored in the level-one cache invalid, in lines of the two-level cache memory.

4. The multi-processor system according to claim 1, wherein the level-two cache has a line size which is k (k: integer of 2 or larger) times as large as the level-one cache.

5. The multi-processor system according to claim 2, wherein the level-two cache has a line size which is k (k: integer of 2 or larger) times as large as the level-one cache.

6. The multi-processor system according to claim 3, wherein the level-two cache has a line size which is k (k: integer of 2 or larger) times as large as the level-one cache.

7. The multi-processor system according to claim 1, wherein in the case where requested data of the processor core is not stored in the level-two cache memory and an instruction code included in the requested data is stored in a plurality of level-one caches which do not correspond to the processor core, the level-two cache controller transfers the instruction code to the level-one cache corresponding to the processor core.

8. The multi-processor system according to claim 7, wherein the level-two cache is connected to a main memory which stores predetermined data,
in the case where the requested data is not stored in the level-two cache memory and an instruction code included in the requested data is not stored in a plurality of level-one caches which do not correspond to the processor core, the level-two cache controller transfers the requested data which is stored in the main memory to the level-one cache corresponding to the processor core.

9. The multi-processor system according to claim 7, wherein the level-two cache is connected to a main memory which stores predetermined data,
in the case where the requested data is not stored in the level-two cache memory and not-requested data is stored in the plurality of level-one caches, the level-two cache controller sets a line bit in the level-two cache tag memory.

10. The multi-processor system according to claim 7, wherein the level-two cache is connected to a main memory which stores predetermined data,
in the case where the requested data is not stored in the level-two cache memory and the plurality of level-one caches, prior to sending a request to transfer requested data to the main memory, the level-two cache controller checks whether or not not-requested data to be stored in the level-two cache memory together with the requested data exists in the plurality of level-one caches.

11. The multi-processor system according to claim 10, wherein in the case where not-requested data to be stored in a line in the level-two cache memory together with the requested data does not exist in the plurality of level-one caches, the level-two cache controller sends a request to transfer data of an amount of line size of the level-two cache memory, in data stored in the main memory.

12. The multi-processor system according to claim 10, wherein in the case where not-requested data to be stored in a line in the level-two cache memory together with the requested data exists in the plurality of level-one caches, the level-two cache controller sends a request to transfer only the requested data, in data stored in the main memory.

13. The multi-processor system according to claim 2, wherein in the case where requested data of the processor core is not stored in the level-two cache memory and an instruction code included in the requested data is stored in a plurality of level-one caches which do not correspond to the processor core, the level-two cache controller transfers the instruction code to the level-one cache corresponding to the processor core.

14. The multi-processor system according to claim 13, wherein the level-two cache is connected to a main memory which stores predetermined data,
in the case where the requested data is not stored in the level-two cache memory and an instruction code included in the requested data is not stored in a plurality of level-one caches which do not correspond to the processor core, the level-two cache controller transfers the requested data which is stored in the main memory to the level-one cache corresponding to the processor core.

15. The multi-processor system according to claim 13, wherein the level-two cache is connected to a main memory which stores predetermined data,
in the case where the requested data is not stored in the level-two cache memory and not-requested data is stored in the plurality of level-one caches, the level-two cache controller sets a line bit in the level-two cache tag memory.

16. The multi-processor system according to claim 13, wherein the level-two cache is connected to a main memory which stores predetermined data,
in the case where the requested data is not stored in the level-two cache memory and the plurality of level-one caches, prior to sending a request to transfer requested data to the main memory, the level-two cache controller checks whether or not not-requested data to be stored in the level-two cache memory together with the requested data exists in the plurality of level-one caches.

17. The multi-processor system according to claim 16, wherein in the case where not-requested data to be stored in a line in the level-two cache memory together with the requested data does not exist in the plurality of level-one caches, the level-two cache controller sends a request to transfer data of an amount of line size of the level-two cache memory, in data stored in the main memory.

18. The multi-processor system according to claim 16, wherein in the case where not-requested data to be stored in a line in the level-two cache memory together with the requested data exists in the plurality of level-one caches, the level-two cache controller sends a request to transfer only the requested data, in data stored in the main memory.

19. A method of controlling a multi-processor system comprising:
a plurality of processor cores which requests and processing data;
a plurality of level-one caches connected to the plurality of processor cores in a one-to-one corresponding manner; and
a level-two cache shared by the plurality of processor cores and whose line size is larger than that of the level-one cache,
wherein the method comprises:
referring to a line bit indicative of whether an instruction code included in data stored in the level-two cache is stored in the plurality of level-one cache or not; and
releasing a line in which data including the same instruction code as that stored in the level-one cache is stored, in lines in the level-two cache memory.

20. The method of controlling a multi-processor system according to claim 19, wherein a replace bit indicative of a way to which a line that stores data including the same instruction code as that stored in the level-one cache belongs is set in the level-two cache.
